(19) United States
(12) Patent Application Publication
(10) Pub. No.: US 2024/0019813 A1
(43) Pub. Date: Jan. 18, 2024

(54) Train Wheel Bridge Decorating Method, Train Wheel Bridge, And Timepiece

(71) Applicant: SEIKO EPSON CORPORATION, Tokyo (JP)

(72) Inventors: Misaki KIKUCHI, Shiojiri (JP); Kazuyuki HARA, Suwa (JP); Kazunori HOSHINO, Matsumoto (JP)

(21) Appl. No.: 18/350,328

(22) Filed: Jul. 11, 2023

(30) Foreign Application Priority Data
Jul. 12, 2022 (JP) 2022-111580

(51) Int. Cl. G04B 29/02; G04B 45/00

(52) U.S. Cl. CPC G04B 29/022; G04B 29/027; G04B 45/0015

(57) ABSTRACT

A method for decorating a train wheel bridge including a jewel includes: a cutting step for forming a plurality of groove portions at a first surface of the train wheel bridge; a smoothing step for smoothening a top portion formed between the groove portions adjacent to each other; a roughening step for roughening a decorative portion including the groove portions and a smooth portion as a result of the smoothing step; and a drilling step for forming a jewel receiving hole extending from the first surface to a second surface on an opposite side to the first surface.

The present application is based on, and claims priority from JP Application Serial Number 2022-111580, filed Jul. 12, 2022, the disclosure of which is hereby incorporated by reference herein in its entirety.

### BACKGROUND

### 1. Technical Field

The present disclosure relates to a method for decorating a train wheel bridge, a train wheel bridge, and a timepiece including the train wheel bridge.

### 2. Related Art

For example, JP-A-2003-72293 discloses a boxwood pattern processing machine for forming a boxwood pattern including multiple circular continuous patterns on a case back, a movement, a bridge, or the like. JP-A-2003-72293 claims that the processing time can be shortened with a processing method using the processing machine.

However, application of the processing method of JP-A-2003-72293 to a train wheel bridge might result in compromised appearance. Specifically, a jewel that receives a shaft of a rotating component such as a gear is embedded in the train wheel bridge and the jewel is driven after a process to form a pattern, that is, after the decoration, meaning that a decorative portion might be damaged during the driving.

### SUMMARY

A method for decorating a train wheel bridge including a jewel according to an aspect of the present application includes a cutting step for forming a plurality of groove portions at a first surface of the train wheel bridge, a smoothening step for smoothening a top portion formed between the groove portions adjacent to each other, a roughening step for roughening a decorative portion including the groove portions and a smooth portion as a result of the smoothing step, and a drilling step for forming a jewel receiving hole extending from the first surface to a second surface on an opposite side to the first surface.

A train wheel bridge according to an aspect of the present application includes a first surface, a second surface on an opposite side to the first surface, a plurality of groove portions formed at the first surface, a smooth portion obtained by smoothing a top portion between the groove portions adjacent to each other, a jewel receiving hole extending from the first surface to the second surface, and a jewel embedded in the jewel receiving hole, wherein the plurality of groove portions are formed at an equal interval at the first surface, and a surface roughness of bottom portions of the groove portions is lower than or is same as a surface roughness of the smooth portion.

A timepiece according to an aspect of the present application includes the train wheel bridge described above and hands including a minute hand and an hour hand.

### BRIEF DESCRIPTION OF THE DRAWINGS

FIG. 1 is a back view of a timepiece according to a first embodiment.

FIG. 2 is a cross-sectional view taken along line b-b of FIG. 1.

FIG. 3 is an enlarged cross-sectional view taken along line c-c of FIG. 1.

FIG. 4 is a schematic configuration diagram of a processing device.

FIG. 5 is a flowchart illustrating a flow of a method of manufacturing a train wheel bridge.

FIG. 6 is a cross-sectional view illustrating a state of the train wheel bridge during a manufacturing process.

FIG. 7 is a cross-sectional view illustrating a state of the train wheel bridge during a manufacturing process.

FIG. 8 is a cross-sectional view illustrating a state of the train wheel bridge during a manufacturing process.

FIG. 9 is a cross-sectional view illustrating a state of the train wheel bridge during a manufacturing process.

FIG. 10 is a cross-sectional view illustrating a state of the train wheel bridge during a manufacturing process.

FIG. 11 is a photograph illustrating an enlarged view of a decorative portion.

### DESCRIPTION OF EXEMPLARY EMBODIMENTS

### First Embodiment

Overview of Timepiece

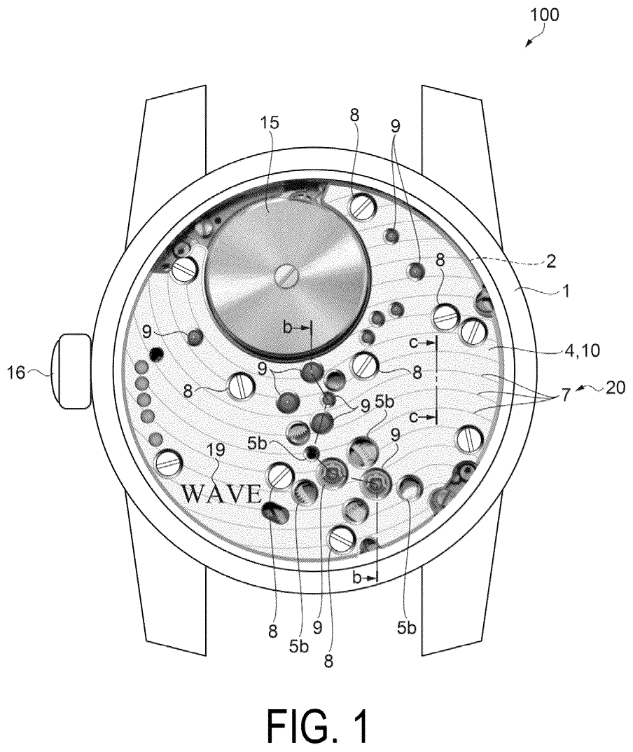

FIG. 1 is a back view of a timepiece according to the present embodiment.

A timepiece 100 according to the present embodiment is a three-hand type analog wristwatch, and FIG. 1 is a plan view illustrating the back surface thereof.

The timepiece 100 is a what is known as a see-through back wristwatch, and has a transparent case back 2 attached to a case body 1 so that the internal mechanism can be observed.

The case body 1, which is a case, is made of hard metal such as titanium or stainless steel. The case body 1 is substantially circular, and has the case back 2 fit to the inner circumference of the ring-shaped wall of the case body 1. A crown 16 is provided on a side surface of the case body 1. The case back 2 is made of a transparent glass member such as sapphire glass.

A movement 10 for driving the hands is housed inside the case body 1. In FIG. 1, a train wheel bridge 4 which is a receiving plate for the movement 10 can be seen through the case back 2.

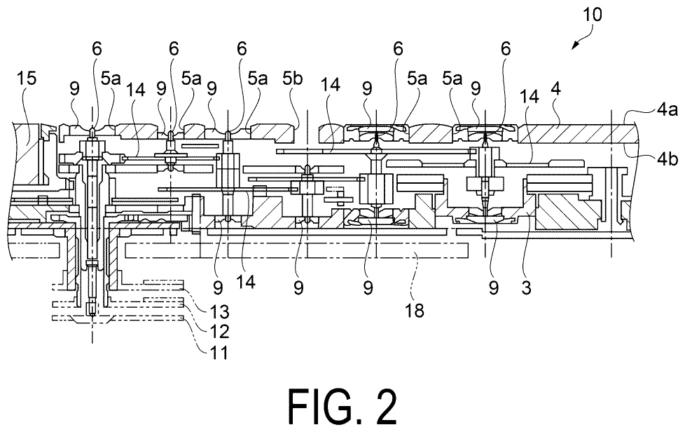

The train wheel bridge 4 has a decorative portion 20 formed to include a plurality of groove portions 7 in a wavy shape. Details of the decorative portion 20 will be described below. A substantially circular notched portion is provided on the 12 o'clock side of the train wheel bridge 4, and a circular barrel 15 can be seen through the notched portion. The train wheel bridge 4 is provided with a plurality of through holes 5. The through holes 5 are classified into a jewel receiving hole 5a (FIG. 2) in which a jewel 9 is embedded and a through hole 5b that is simply a hole. A part of the gears forming a gear train can be seen through the through hole 5b.

The train wheel bridge 4 is further provided with a plurality of screws 8 for fixing the train wheel bridge 4.

The timepiece 100 has the train wheel bridge 4 provided with a design imitating a dry landscape garden formed by the decorative portion 20 including the plurality of groove portions 7, the plurality of jewels 9, the through holes 5, the screws 8, and the like. More specifically, a river flow is expressed by the plurality of groove portions 7 in a wavy shape, and riverside and mountain scenery are expressed by the jewels 9, the through holes 5, and the screws 8. A logo 19 is engraved on the 6 o'clock side of the train wheel bridge 4. In FIG. 1, the letters “WAVE” are engraved through laser processing, but the configuration is not limited to these letters, and the letters may be appropriately set in accordance with product specifications and design.

FIG. 2 is a cross-sectional view taken along line b-b in FIG. 1, and illustrates a cross section of a portion passing through the plurality of jewels 9 and the through holes 5b.

As illustrated in FIG. 2, the movement 10 includes a gear train including a plurality of gears 14 and the like between the bottom plate 3 and the train wheel bridge 4.

A dial 18 is attached to one surface of the bottom plate 3, and a second hand 11, a minute hand 12, and an hour hand 13 are attached to the center of the dial 18. Note that the hands may only include the minute hand 12 and the hour hand 13.

The gear 14 is provided with a rotational shaft 6, and the rotational shaft 6 is inserted into the jewel 9 embedded in the train wheel bridge 4 to be rotatably supported. Specifically, the jewel 9 is inserted in the jewel receiving hole 5a formed in the train wheel bridge 4, and the rotational shaft 6 is inserted in a center hole of the jewel 9. Note that the jewel 9 is also referred to as a hole jewel. The jewel 9 is similarly provided on the bottom plate 3 side, and the plurality of gears 14 are rotatably supported by the jewel 9 on the bottom plate 3 side and the jewel 9 on the train wheel bridge 4 side. A surface of the train wheel bridge 4 on the case back 2 side is referred to as a first surface 4a. A surface on the side opposite to the first surface 4a is referred to as a second surface 4b. The decorative portion 20 including the plurality of groove portions 7 (FIG. 1) described above is formed on the first surface 4a.

As will be described in detail below, the jewel 9 is driven from the second surface 4b. In other words, the train wheel bridge 4 includes the jewel receiving hole 5a extending from the first surface 4a to the second surface 4b, and the jewel 9 embedded in the jewel receiving hole 5a.

Configuration of Decorative Portion

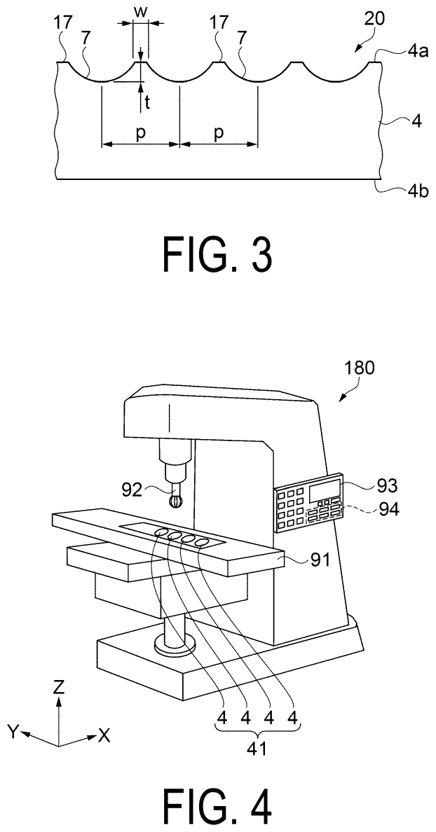

FIG. 3 is an enlarged cross-sectional view taken along line c-c in FIG. 1.

As illustrated in FIG. 3, the decorative portion 20 includes the plurality of groove portions 7 formed on the first surface 4a of the train wheel bridge 4, a smooth portion 17 formed by smoothing a top portion between the adjacent groove portions 7, and the like.

In a preferred example, a brass plate member is used for the train wheel bridge 4. It should be noted that the material is not limited to this, and any metal member having similar physical properties may be used.

An interval p between the adjacent groove portions 7 is approximately 1.5 mm in a preferred example. In other words, the plurality of groove portions 7 are formed at a substantially equal interval at the first surface 4a.

The smooth portion 17 is a portion where an edge portion, generated between the adjacent groove portions 7 as a result of a process of forming the groove portions 7 using a ball endmill, is smoothed by a square endmill. In a preferred example, a width w of the smooth portion 17 is about 0.2 mm. A height t from the deepest portion of the groove portion 7 to the smooth portion 17 is about 0.08 mm in a preferred example. These dimensions are merely examples, and may be appropriately set in accordance with the design of the decorative portion 20.

The decorative portion 20 including the groove portion 7 and the smooth portion 17 is subjected to a roughening treatment described below. As a result, the surface roughness on the bottom portion of the groove portion 7 is lower than or substantially the same as the surface roughness of the smooth portion 17. As a result, the decorative portion 20 having a matte and stereoscopic appearance in which metallic luster as a result of cutting is suppressed is obtained.

Method for Manufacturing Train Wheel Bridge

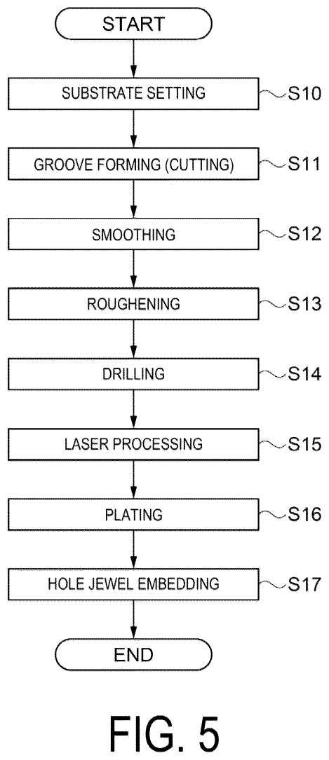

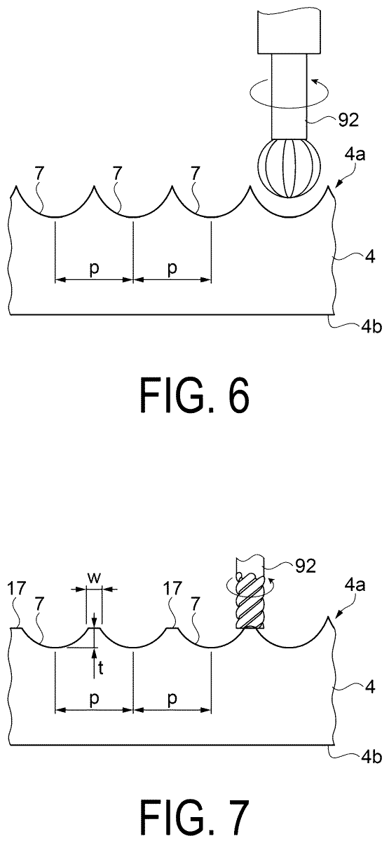

FIG. 4 is a schematic view of a processing device. FIG. 5 is a flowchart illustrating a flow of a method of manufacturing the train wheel bridge. FIGS. 6 to 10 are cross-sectional views of the train wheel bridge in the manufacturing process, and correspond to FIG. 3.

A method of manufacturing the train wheel bridge 4 will be described while focusing on the decorative portion 20. In other words, a method for decorating the train wheel bridge 4 will be described.

First, an overview of a processing device 180 used for manufacturing the train wheel bridge 4 will be described with reference to FIG. 4. The processing device 180 is a machining center, and includes an XY table 91, a control device 93, a tool 92, and the like.

The XY table 91 is a processing table, and moves a workpiece set on the table in an X direction and a Y direction in accordance with an instruction from the control device 93. In FIG. 4, on the XY table 91, a short substrate 41 on which a plurality of train wheel bridges 4 are attached is set.

The control device 93 is a controller for the processing device 180, includes one or a plurality of processors, and comprehensively controls the operations of the units. The control device 93 includes a storage unit 94 including a nonvolatile memory. The storage unit 94 stores a control program for controlling the operation of the processing device 180, a decoration program to be described below, various types of data, and the like. The decoration program defines the order and contents for forming the decorative portion 20 including the groove portions 7 and the smooth portion 17. The various types of data include wavy scanning pattern data and the like.

The tool 92 is a tool such as a cutting tool for processing or a brush, and is automatically replaced in accordance with an instruction from the control device 93. In FIG. 4, a ball endmill is attached which is initially used as the tool 92. The tool 92 moves in the Y-axis direction, rotates, and stops rotating in accordance with an instruction from the control device 93.

In step S10, the short substrate 41 on which a plurality of the train wheel bridges 4 are attached is set to the processing device 180. Then, an operator performs an operation of activating the decoration program, on the control device 93. As a result, the decoration program is activated, and the following processing from step S11 to step S14 is executed.

In step S11, a plurality of groove portions 7 are formed on the first surface 4a of the train wheel bridge 4. Specifically, the ball endmill is used as the tool 92 to form the plurality of groove portions 7 in a wavy shape (FIG. 1). In a preferred example, an R5 mm ball endmill is used to form the groove portions 7 with the interval p of about 1.5 mm. Note that the dimension is not limited to this, and may be appropriately adjusted in accordance with the design. This step corresponds to a cutting step, and when this process is completed, as illustrated in FIG. 6, the top portion between the adjacent groove portions 7 has a sharp edge shape.

In step S12, the top portion between the adjacent groove portions 7 is smoothed. Specifically, as illustrated in FIG. 7, the square endmill is used as a tool 92 to grind and smooth the top portion between the groove portions 7. In a preferred example, the smooth portion 17 is formed to have the width w of about 0.2 mm. The height t from the deepest portion of the groove portion 7 to the smooth portion 17 is about 0.08 mm. This step corresponds to a smoothing step, and at the time when this process is completed, the groove portion 7 and the smooth portion 17 have a metallic luster surface.

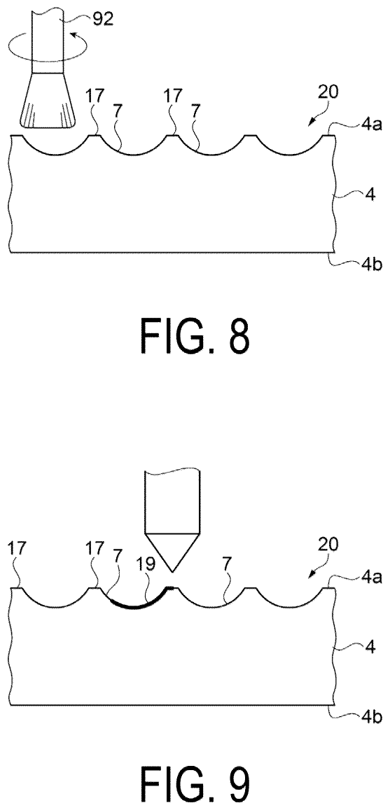

In step S13, the decorative portion 20 including the groove portion 7 and the smooth portion 17 is roughened. Specifically, as illustrated in FIG. 8, a polishing brush is used as the tool 92 to polish the groove portion 7 and the smooth portion 17. This step corresponds to a roughening step. In a preferred example, all the groove portions 7 and the smooth portions 17 are scanned and polished one by one along the extending direction of the groove portions 7, with a rotating polishing brush using ceramic fibers as a polishing material. The target of the polishing is the surface roughness of the bottom portion of the groove portions 7 that is substantially equal to or lower than the surface roughness of the smooth portion 17. Further, the polishing brush is not limited to the polishing brush using the ceramic fiber, but may be any brush capable of performing similar polishing. For example, a brush using a metal wire such as a brass wire or a steel wire may be used. This step corresponds to a roughening step, and by this step, the decorative portion 20 becomes matte, and the matte and stereoscopic decorative portion 20 is formed.

In step S14, the plurality of jewel receiving holes 5a and through holes 5b are formed. Specifically, a drill is used as the tool 92 to drill the jewel receiving hole 5a and the through hole 5b. As illustrated in FIG. 1, the jewel receiving holes 5a and the through holes 5b have a plurality of hole diameters, and thus the drilling is performed with the drill replaced for each hole diameter. This step corresponds to a drilling step, and the process up to this step is performed by the processing device 180 only. In other words, in the drilling step, the jewel receiving hole 5a is extending from the first surface 4a to the second surface 4b on the side opposite to the first surface 4a.

In a preferred example, the process up to this step is performed by the processing device 180, but the present disclosure is not limited to this, and for example, the roughening step or the drilling step may be performed by another processing device, as long as the necessary process is performed.

In step S15, the short substrate 41 to which the plurality of train wheel bridges 4 are attached is set to a laser processing device (not illustrated), to engrave the logo 19. In a preferred example, femtosecond pulsed laser irradiation is used to engrave the logo 19. This step corresponds to a laser irradiation step, and as illustrated in FIG. 9, clear engraving can be performed following in accordance with an uneven shape of the groove portions 7 and the smooth portions 17 by using laser processing. The laser irradiation step may be performed before the drilling step.

In step S16, the train wheel bridge 4 is subjected to plating. Specifically, the train wheel bridges 4 are cut out from the short substrate 41, and are individually subjected to the plating treatment. In a preferred example, the entire surface of the train wheel bridge 4 is subjected to electrolytic nickel plating.

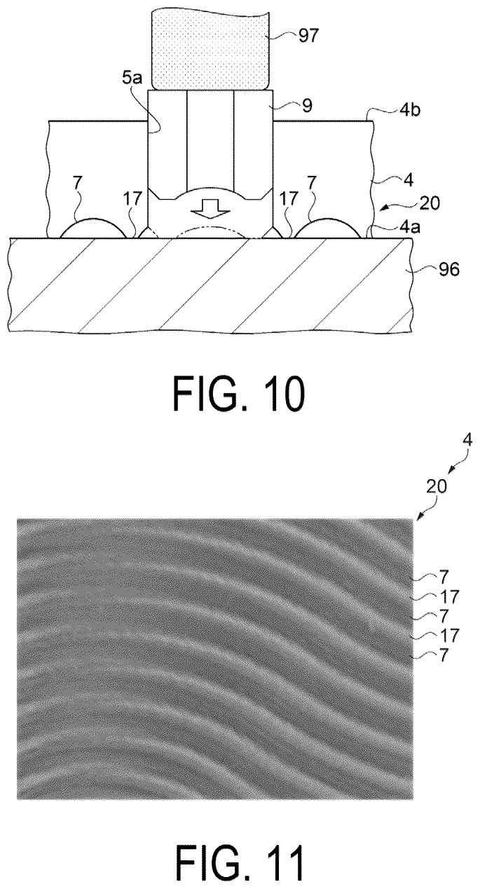

In step S17, the jewel 9 is embedded in the train wheel bridge 4. This step corresponds to an embedding step, and as illustrated in FIG. 10, the jewel 9 is pushed into the jewel receiving hole 5a from the second surface 4b in a state where the train wheel bridge 4 is set on a base portion 96 of a dedicated jig with the first surface 4a facing downward. The diameter of the jewel receiving hole 5a is set to be slightly smaller than the outer shape of the jewel 9. In other words, the jewel 9 provides a tightening allowance for the jewel receiving hole 5a. In a preferred example, the surface on the insertion side of the jewel 9 on the insertion side is chamfered. Pushing is performed by a pushing rod 97 of a dedicated jig. In a preferred example, a plurality of the pushing rods 97 are attached to the dedicated jig, and the plurality of jewels 9 can be embedded by a single operation.

Mode of Decorative Portion

FIG. 11 is a photograph illustrating an enlarged view of the decorative portion.

FIG. 11 is a photograph of the decorative portion 20 of the train wheel bridge 4 processed by the above-described manufacturing method.

As illustrated in FIG. 11, waves of the dry landscape garden are expressed by the plurality of groove portions 7. Since the decorative portion 20 including the smooth portion 17 has been subjected to the roughening treatment, matte and stereoscopic waves in the dry landscape garden are expressed.

Further, as illustrated in FIG. 1, the jewel 9, the through holes 5, and the screws 8 provide a scenery in addition to the wave pattern. Thus, the design imitating the dry landscape garden including riverside and mountain scenery is expressed.

In the roughening step described above, when the surface roughness on the bottom portion of the groove portion 7 is lower than the surface roughness of the smooth portion 17, the bottom of the groove portion 7 has strong metallic luster and the smooth portion 17 is matte, resulting in a varying pattern. To achieve the surface roughness, for example, adjustment may be performed to weaken the pressing pressure of the polishing brush so that the bottom portion of the groove portion 7 is not excessively polished.

When the surface roughness of the bottom portion of the groove portion 7 is substantially the same as the surface roughness of the smooth portion 17 as a result of the roughening step described above, the decorative portion 20 has a substantially uniform a surface roughness, and the design can have a sense of uniformity (consistency).

According to the train wheel bridge 4, the method for decorating the train wheel bridge 4, and the timepiece 100 of the present embodiment described above, the following advantages can be obtained.

A method for decorating the train wheel bridge 4 including the jewel 9 includes: the cutting step for forming the plurality of groove portions 7 on the first surface 4a of the train wheel bridge 4; the smoothing step for smoothening the top portion formed between the groove portions 7 adjacent to each other; and the roughening step for roughening the decorative portion 20 including the groove portions 7 and the smooth portion 17 as a result of the smoothing step; and the drilling step for forming the jewel receiving hole 5a extending from the first surface 4a to a second surface 4b on an opposite side to the first surface 4a.

In a preferred example, the plurality of groove portions 7 are formed in a wavy shape expressing a dry landscape garden. Since the decorative portion 20 including the top portion has been subjected to the roughening treatment, the decorative portion 20 having a dry landscape garden of a matte and stereoscopic appearance can be obtained.

Since the top portion which is the most protruding portion in the decorative portion 20 is smoothed, the jewel 9 can be driven from the second surface 4b with the first surface 4a on which the decorative portion 20 is formed facing downward, without causing a damage on the decorative portion 20 such as crushing of the top portion.

Thus, a method for decorating the train wheel bridge 4 including the decorative portion 20 with excellent appearance can be provided.

The method for decorating further includes the embedding step for embedding the jewel 9 into the jewel receiving hole 5a from the second surface 4b.

The embedding step is performed after the roughening step, so that the jewel 9 can be driven with the first surface 4a facing downward, without causing a damage on the decorative portion 20 such as crushing of the top portion.

The cutting step is performed using a ball endmill, and the plurality of groove portions 7 are formed at a substantially equal interval.

Thus, waves in a dry landscape garden can be expressed by the plurality of groove portions 7.

The smoothing step is performed using a square endmill.

Thus, a sharp top portion between the groove portions 7 as a result of the cutting step can be efficiently smoothed.

The roughening step is performed using a brush.

Thus, the roughening treatment can be efficiently performed on the decorative portion 20.

The method further includes the laser irradiation step for engraving the decorative portion 20 through laser irradiation. Thus, the logo 19 and the like can be clearly engraved on the decorative portion 20 with unevenness.

The train wheel bridge 4 includes: the first surface 4a; the second surface 4b on an opposite side to the first surface 4a; the plurality of groove portions 7 formed on the first surface 4a; the smooth portion 17 obtained by smoothing the top portion between the groove portions 7 adjacent to each other; the jewel receiving hole 5a extending from the first surface 4a to the second surface 4b; and the jewel 9 embedded in the jewel receiving hole 5a, wherein the plurality of groove portions 7 are formed at a substantially equal interval at the first surface 4a, and a surface roughness of bottom portions of the groove portions 7 is lower than or is substantially the same as a surface roughness of the smooth portion 17.

As a result, the train wheel bridge 4 includes the decorative portion 20 having a matte and stereoscopic appearance in which metallic luster as a result of cutting is suppressed.

Since the top portion which is the most protruding portion in the decorative portion 20 is smoothed, the jewel 9 can be driven from the second surface 4b with the first surface 4a on which the decorative portion 20 is formed facing downward, without causing a damage on the decorative portion 20 such as crushing of the top portion.

Thus, the train wheel bridge 4 including the decorative portion 20 with excellent appearance can be provided.

On the first surface 4a, the plurality of groove portions 7 are formed in a wavy shape expressing a dry landscape garden. Thus, waves in a dry landscape garden can be expressed by the plurality of groove portions 7.

The surface roughness of the bottom portions of the groove portions 7 is lower than the surface roughness of the smooth portion 17.

Thus, a varying pattern can be obtained with the bottom portions of the groove portions 7 having strong metallic luster, and the smooth portion 17 being matte.

The surface roughness of the bottom portions of the groove portions 7 is substantially the same as the surface roughness of the smooth portion 17.

Thus, the decorative portion 20 has uniform a surface roughness, resulting in a design with a sense of uniformity (consistency).

The timepiece 100 includes the train wheel bridge 4 described above.

Thus, the timepiece 100 including the train wheel bridge 4 provided with a design featuring excellent appearance can be provided.

Modifications

The logo 19 is described as being engraved through laser irradiation in step S15 described above. However, this should not be construed in a limiting sense. The engraving can be performed on the decorative portion 20 in any manner, and can be manually performed for example.

The train wheel bridge 4 is described above to be provided with a design imitating a dry landscape garden using the decorative portion 20 and the like. However, this should not be construed in a limiting sense, and other kinds of design can be provided. For example, a design including a plurality of quadrangular frustums in a lattice pattern formed by a plurality of grooves intersecting each other may be provided. Such a lattice pattern may be incorporated in part of the dry landscape garden design.

What is claimed is:

1. A method for decorating a train wheel bridge including a jewel, the method comprising:
a cutting step for forming a plurality of groove portions at a first surface of the train wheel bridge;
a smoothening step for smoothening a top portion formed between the groove portions adjacent to each other;
a roughening step for roughening a decorative portion including the groove portions and a smooth portion as a result of the smoothing step; and
a drilling step for forming a jewel receiving hole extending from the first surface to a second surface on an opposite side to the first surface.

2. The method for decorating a train wheel bridge according to claim 1 further comprising an embedding step for embedding the jewel into the jewel receiving hole from the second surface.

3. The method for decorating a train wheel bridge according to claim 1, wherein
the cutting step is performed using a ball endmill, and
the plurality of groove portions are formed at an equal interval.

4. The method for decorating a train wheel bridge according to claim 1, wherein the smoothing step is performed using a square endmill.

5. The method for decorating a train wheel bridge according to claim 1, wherein the roughening step is performed using a brush.

6. The method for decorating a train wheel bridge according to claim 1 further comprising a laser irradiation step for engraving the decorative portion through laser irradiation.

7. A train wheel bridge comprising:
a first surface;
a second surface on an opposite side to the first surface;
a plurality of groove portions formed at the first surface;
a smooth portion obtained by smoothing a top portion between the groove portions adjacent to each other;
a jewel receiving hole extending from the first surface to the second surface; and
a jewel embedded in the jewel receiving hole, wherein
the plurality of groove portions are formed at an equal interval at the first surface, and
a surface roughness of bottom portions of the groove portions is lower than or is same as a surface roughness of the smooth portion.

8. The train wheel bridge according to claim 7, wherein, at the first surface, the plurality of groove portions are formed in a wavy shape expressing a dry landscape garden.

9. The train wheel bridge according to claim 7, wherein the surface roughness of the bottom portions of the groove portions is lower than the surface roughness of the smooth portion.

10. The train wheel bridge according to claim 7, wherein the surface roughness of the bottom portions of the groove portions is same as the surface roughness of the smooth portion.

11. A timepiece comprising the train wheel bridge described in claim 7.
